(19) United States
(12) Patent Application Publication
(10) Pub. No.: US 2026/0246184 A1
(43) Pub. Date: Aug. 20, 2026

(54) CONNECTOR

(71) Applicant: SUMITOMO WIRING SYSTEMS, LTD., Mie (JP)

(72) Inventors: Tomoki SUZUKI, Mie (JP); Junpei KAWAHARA, Mie (JP)

(21) Appl. No.: 19/537,023

(22) Filed: Feb. 11, 2026

(30) Foreign Application Priority Data
Feb. 17, 2025 (JP) 2025-022986

(51) Int. Cl. H01R 13/422; H01R 13/11; H01R 13/41

(52) U.S. Cl. CPC H01R 13/4223; H01R 13/113; H01R 13/41

(57) ABSTRACT

A housing has a wall portion having a thickness in a first direction and holding holes extending in the wall portion in the first direction. Inner surfaces of each holding hole consist of a pair of second inner surfaces facing each other in a second direction and a pair of third inner surfaces facing each other in a third direction. Each terminal fitting has a held portion that is disposed in the holding hole. The held portion has a pair of second outer surfaces, a pair of third outer surfaces, and a pair of engaging portions protruding outward from the third outer surfaces. The engaging portions of the held portion are engaged with the third inner surfaces of the holding hole. The second outer surfaces of the held portion are disposed close to or in contact with the respective second inner surfaces of the holding hole along the third direction.

### CROSS-REFERENCE TO RELATED APPLICATIONS

This application is based on and claims priority from Japanese Patent Application No. 2025-022986, filed on February 17, 2025, with the Japan Patent Office, the disclosure of which is incorporated herein in its entirety by reference.

### TECHNICAL FIELD

The present disclosure relates to a connector.

### BACKGROUND

JP 2010-040257 A discloses a connector including terminal fittings and a housing. The housing has terminal holding portions configured to hold the terminal fittings. Each of the terminal fittings has a rectangular cross-section, and include a lower surface, an upper surface, and a pair of side surfaces. Each of the terminal holding portions has a bottom wall, a ceiling wall, and a pair of side walls. The side walls interfere with the side surfaces, respectively. The bottom wall has a lower interfering portion that interferes with a portion of the lower surface. The ceiling wall has an upper interfering portion that interferes with a portion of the upper surface.

### SUMMARY

When the terminal fitting is pressed into the terminal holding portion, the side surfaces interfere with the side walls, respectively, and a portion of the lower surface interferes with the bottom wall, and a portion of the upper surface interferes with the ceiling wall. When the terminal fitting is pressed by the terminal holding portion in a left-right direction and an up-down direction at a large number of interference sites between the terminal fitting and the terminal holding portion in this manner, that is a concern that the terminal fitting may be likely to be displaced relative to the terminal holding portion due to variation in the manner the terminal fitting is press-fitted into the terminal holding portion, and the like, and the holding position will not be fixed at a constant position. If the holding position where the terminal fitting is held by the terminal holding portion is not fixed at a constant position, coplanarity may decrease, resulting in a mounting failure.

In view of this, an object of the present disclosure is to provide a connector in which a terminal is less likely to be displaced, and a mounting failure is less likely to occur.

A connector according to the present disclosure includes: a housing; and a terminal fitting, wherein the housing includes a wall portion having a thickness in a first direction and a holding hole extending in the wall portion in the first direction, the holding hole has a pair of second inner surfaces facing each other in a second direction that intersects the first direction and a pair of third inner surfaces facing each other in a third direction that intersects both the first and second directions, the terminal fitting has a board connection portion connected to a circuit board outside the housing and a held portion disposed in the holding hole, the held portion has a pair of second outer surfaces directed in the second direction, a pair of third outer surfaces directed in the third direction, and a pair of engaging portions protruding outward in the third direction from the pair of third outer surfaces, the pair of engaging portions of the held portion are respectively engaged with the pair of third inner surfaces of the holding hole, the pair of second outer surfaces of the held portion are respectively disposed in contact with or close to the pair of second inner surfaces of the holding hole along the third direction, and a distance in the second direction between the pair of second inner surfaces of the holding hole is set to be equal to or larger than a distance in the second direction between the pair of second outer surfaces of the held portion.

According to the present disclosure, it is possible to provide a connector in which a terminal is less likely to be displaced, and a mounting failure is less likely to occur.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to a first embodiment as viewed from the front.

FIG. 2 is a perspective view of a terminal fitting in the connector according to the first embodiment as viewed from the rear.

FIG. 3 is a back view of the connector according to the first embodiment.

FIG. 4 is an enlarged perspective view of a holding hole provided in a wall portion of a housing and surroundings of the holding hole, in the connector according to the first embodiment.

FIG. 5 is an enlarged back view of a part of the wall portion of the housing and portions of terminal fittings that are drawn out, in the connector according to the first embodiment.

FIG. 6 is a sectional view of the connector according to the first embodiment, taken along the line A-A in FIG. 5.

FIG. 7 is a sectional view of the connector according to the first embodiment, taken along the line B-B in FIG. 5.

FIG. 8 is a diagram of another aspect of the connector according to the first embodiment, corresponding to FIG. 7.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

(1) A connector according to the present disclosure includes: a housing; and a terminal fitting, wherein the housing includes a wall portion having a thickness in a first direction and a holding hole extending in the wall portion in the first direction, the holding hole has a pair of second inner surfaces facing each other in a second direction that intersects the first direction and a pair of third inner surfaces facing each other in a third direction that intersects both the first and second directions, the terminal fitting has a board connection portion connected to a circuit board outside the housing and a held portion disposed in the holding hole, the held portion has a pair of second outer surfaces directed in the second direction, a pair of third outer surfaces directed in the third direction, and a pair of engaging portions protruding outward in the third direction from the pair of third outer surfaces, the pair of engaging portions of the held portion are respectively engaged with the pair of third inner surfaces of the holding hole, the pair of second outer surfaces of the held portion are respectively disposed in contact with or close to the pair of second inner surfaces of the holding hole along the third direction, and a distance in the second direction between the pair of second inner surfaces of the holding hole is set to be equal to or larger than a distance in the second direction between the pair of second outer surfaces of the held portion.

With the configuration in the above (1), the interference sites between the held portion and the wall portion can be limited to the locations where the engaging portions are respectively engaged with the third inner surfaces, and the second outer surfaces of the held portion are not strongly pressed by the respective second inner surfaces of the holding hole. In short, the direction in which the held portion is pressed by the wall portion can be limited to the third direction, and thus the holding position where the held portion is held by the wall portion is less likely to vary. As a result, positional variation of the board connection portion can also be suppressed and coplanarity can be improved.

(2) In the connector according to the above (1), it is preferred that the pair of engaging portions of the held portion have a thickness in the second direction and are respectively engaged with the pair of third inner surfaces over their entire thickness.

With the configuration in the above (2), since the interference sites where the engaging portions are respectively engaged with the third inner surfaces can be maximized in the second direction while limiting the direction in which the held portion is pressed by the wall portion to the third direction, the holding force with which the wall portion holds the held portion can be reliably ensured.

(3) In the connector according to the above (1) or (2), it is preferred that the distance in the second direction between the pair of second inner surfaces of the holding hole is larger than the distance in the second direction between the pair of second outer surfaces of the held portion.

With the configuration in the above (3), it is easy to prevent the held portion from being pressed by the wall portion in the second direction, and thus the holding position where the held portion is held by the wall portion can be made less likely to vary.

### Details of Embodiments of Present Disclosure

The following describes specific examples of the present disclosure with reference to the drawings. Note that the present invention is not limited to these illustrations and is intended to be represented by claims and to include all modifications that are within the meanings and the scope that are equivalent to those of the claims.

### First Embodiment

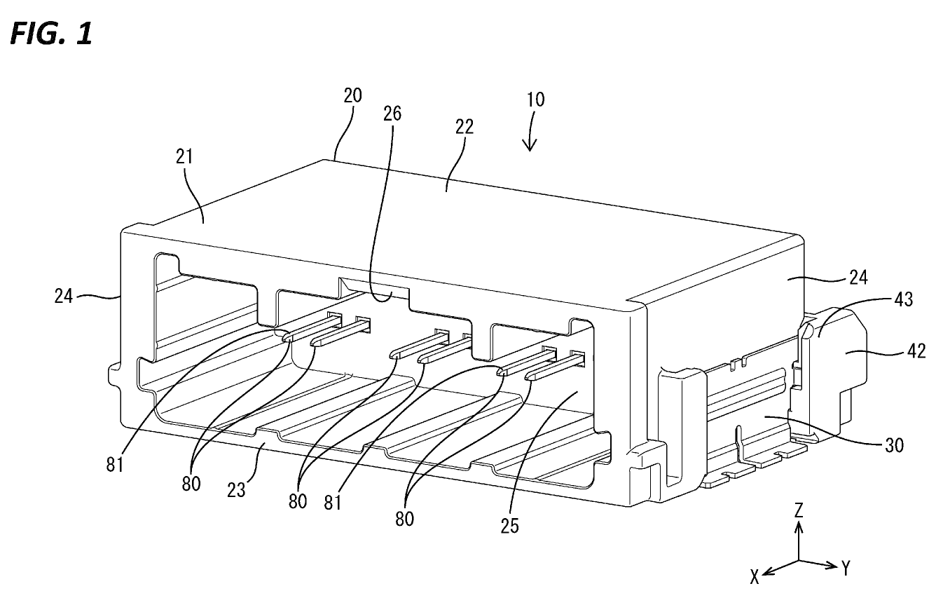

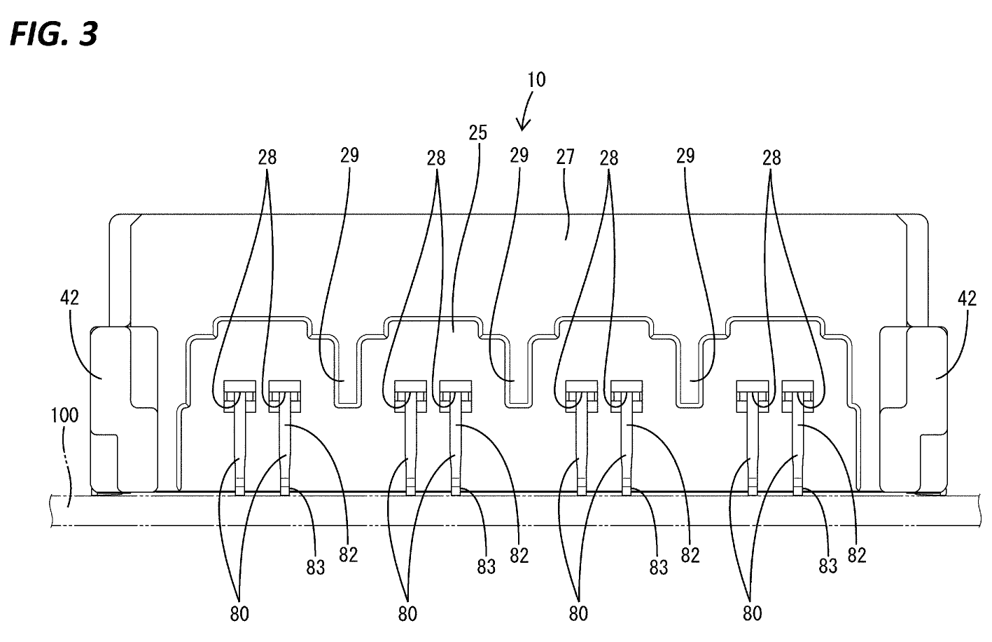

As shown in FIG. 1, a connector 10 in a first embodiment includes a housing 20 and terminal fittings 80. The housing 20 is mated with a mating housing not shown. The terminal fittings 80 are mounted to the housing 20 and are connected to a circuit board 100 (see FIG. 3) outside the housing 20. Note that, in the following description, a front-rear direction may be referred to as a first direction, an up-down direction a second direction, and a left-right direction a third direction. "Front/forward" refers to the arrow direction along the first direction, which in the first embodiment corresponds to a direction in which the terminal fittings 80 are mounted to the housing 20. "Right" refers to the arrow direction along the third direction, which corresponds to a rightward direction as viewed from the rear. "Up/upper" refers to the arrow direction along the second direction, which in the first embodiment corresponds to a direction in which the terminal fittings 80 are mounted to the circuit board 100 (including slight inclination). In FIG. 1, reference signs X, Y, and Z represent the front side (the arrow direction along the first direction), the right side (the arrow direction along the third direction), and the upper side (the arrow direction along the second direction), respectively. These directional references are for convenience, and do not necessarily match directional references when the connector 10 is mounted in a vehicle or the like (not illustrated).

### Terminal Fittings 80

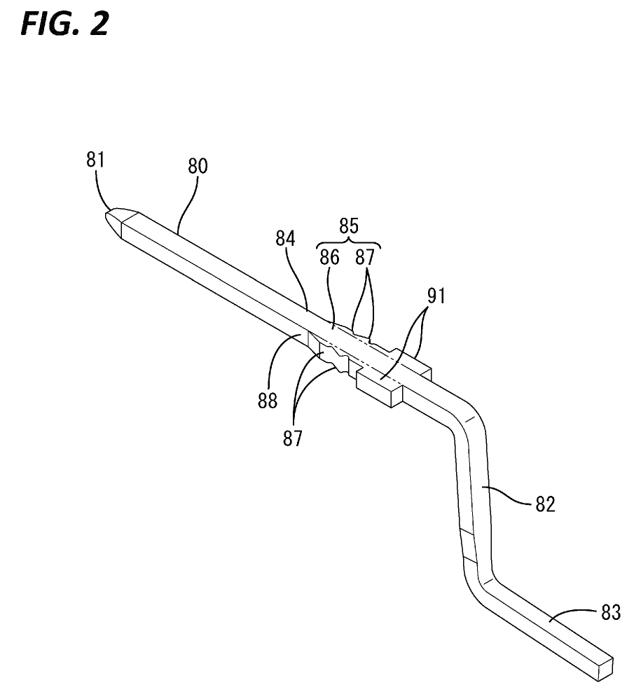

Each of the terminal fittings 80 is made of conductive metal and has a tab or pin shape. As shown in FIG. 2, the terminal fitting 80 includes a mating connection portion 81 extending in the front-rear direction, an intermediate extending portion 82 extending downward from a rear end of the mating connection portion 81, and a board connection portion 83 extending rearward from a lower end of the intermediate extending portion 82.

The mating connection portion 81 is larger in the left-right direction than in the up-down direction and is disposed with the plate surfaces directed in the up-down direction. The mating connection portion 81 has a constant width in the front-rear direction except for a tip end thereof and has an extending portion 84 extending continuously in the front-rear direction.

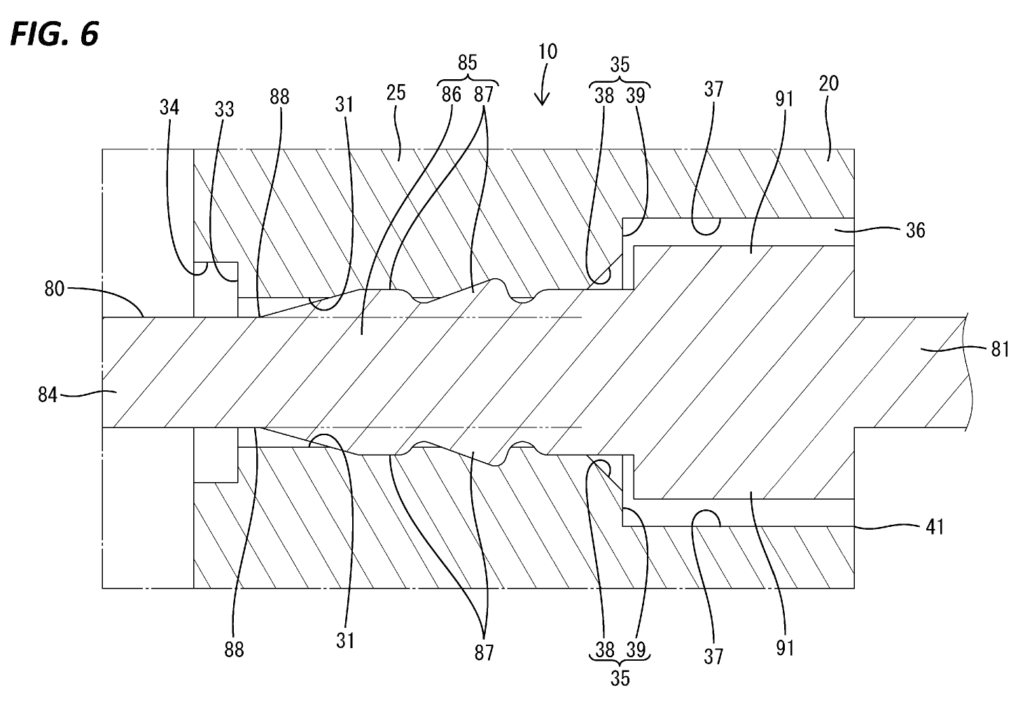

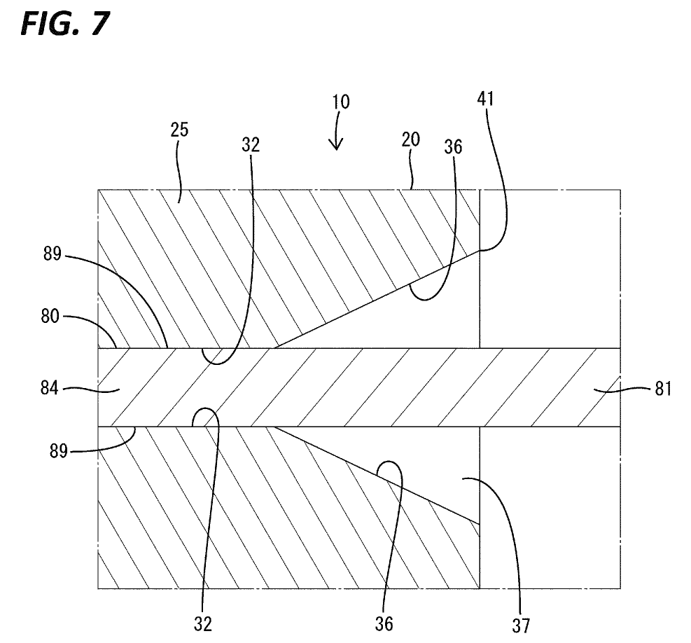

The mating connection portion 81 also has a held portion 85 that is disposed in a later-described holding hole 28 of the housing 20, at a position closer to the rear end of the mating connection portion 81. The held portion 85 has an intermediate portion 86 located at a longitudinally intermediate position of the extending portion 84, and a plurality of engaging portions 87 protruding outward laterally from the intermediate portion 86. The intermediate portion 86 has a rectangular cross section that is larger in the left-right direction than in the up-down direction. Outer surfaces of the intermediate portion 86 consist of a pair of right and left third outer surfaces 88 (see FIG. 6) directed in the left-right direction (third direction) and a pair of upper and lower second outer surfaces 89 (see FIG. 7) directed in the up-down direction (second direction). The second outer surfaces 89 are disposed along the front-rear direction and the left-right direction. The third outer surfaces 88 are disposed along the front-rear direction and the up-down direction. The size of each second outer surface 89 in the left-right direction is larger than the size of each third outer surface 88 in the up-down direction.

The engaging portions 87, having the same thickness (vertical thickness) as the extending portion 84, are continuous with the extending portion 84, and are arranged in the front-rear direction. The engaging portions 87 have a protruding shape and are formed with a constant thickness in the protruding direction in plan view. Bases of the engaging portions 87 are connected to the third outer surfaces 88 of the intermediate portion 86 over the entire thickness in the up-down direction. The engaging portions 87 are press-fitted to later-described third inner surfaces 31 of a holding hole 28 of the housing 20 in such a manner as to bite into the third inner surfaces 31 over the entire height.

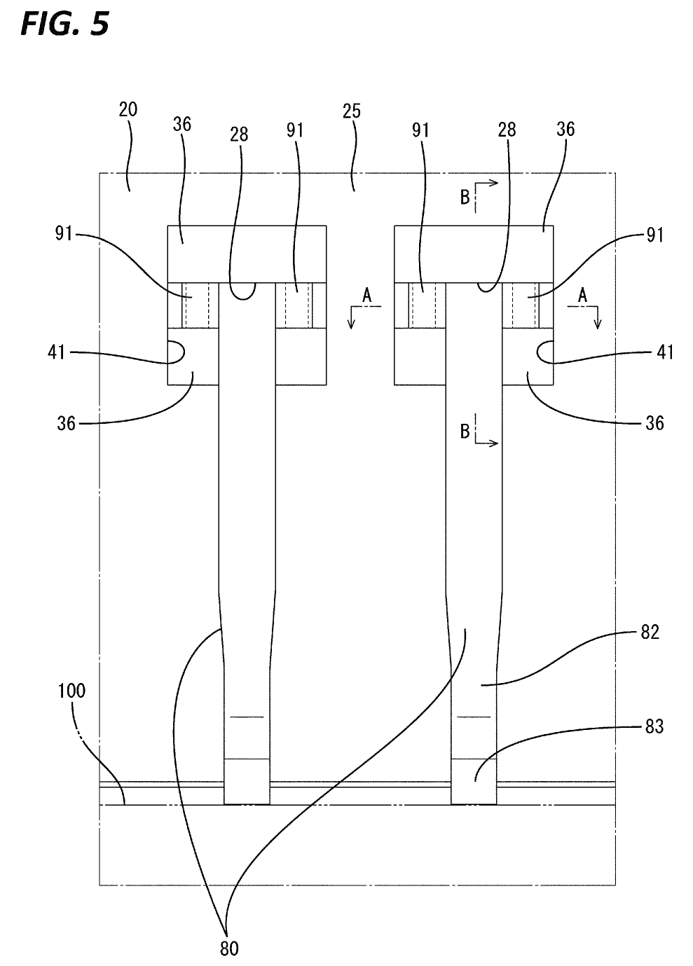

As shown in FIGS. 2 and 6, the mating connection portion 81 has a pair of right and left stoppers 91, at positions rearward of the held portion 85, that face later-described facing surfaces 35 of the housing 20 from the rear. The stoppers 91 have a rectangular plate shape that is longer in the front-rear direction than in the left-right direction in plan view and protrude laterally outward from an intermediate portion in the front-rear direction of the extending portion 84 (rearward of the intermediate portion 86). The stoppers 91, having the same thickness as the extending portion 84, are continuous with the extending portion 84. As shown in FIGS. 3 and 5, the board connection portions 83 are arranged along a surface of the circuit board 100 (upper surface directed in the arrow direction along the second direction).

### Housing 20

As shown in FIG. 1, the housing 20 has a hood portion 21. The hood portion 21 has a rectangular tubular shape and is open forward. The hood portion 21 has a top portion 22, a bottom portion 23, a pair of side portions 24, and a wall portion 25. The top portion 22 and the bottom portion 23 face each other in the up-down direction. The bottom portion 23 is located below the top portion 22 and is placed on the surface of the circuit board 100. The pair of side portions 24 face each other in the left-right direction. The size in the left-right direction of the top portion 22 and the bottom portion 23 is larger than the size in the up-down direction of the pair of side portions 24. The wall portion 25 is disposed at a rear end of the housing 20. The wall portion 25 is connected to the rear ends of the top portion 22, the bottom portion 23, and the pair of side portions 24. The thickness direction of the wall portion 25 corresponds to the front-rear direction. Both the front surface and the rear surface of the wall portion 25 are disposed along the up-down direction and the left-right direction.

A locking portion 26 protrudes into the hood portion 21 from an intermediate portion in the left-right direction of the top portion 22. The locking portion 26 locks to a mating housing (not illustrated) and holds both of the housings in a mated state. A pair of fixing brackets 30 are mounted to right and left outer surfaces of the pair of side portions 24. The fixing brackets 30 are soldered to the surface of the circuit board 100. The housing 20 is fixed to the circuit board 100 via the fixing brackets 30.

As shown in FIG. 3, an upper end of the wall portion 25 has a protruding wall 27. The protruding wall 27 protrudes rearward of a lower portion of the wall portion 25. A plurality of holding holes 28 that extend in the front-rear direction are provided in the lower portion of the wall portion 25. In the wall portion 25, the holding holes 28 are arranged in the left-right direction. Note that, with respect to a structure surrounding each of the holding holes 28, two components for one holding hole 28 is referred to as a "pair". The wall portion 25 has a plurality of hanging walls 29 extending downward from the protruding wall 27, between holding holes 28 that are adjacent in the left-right direction.

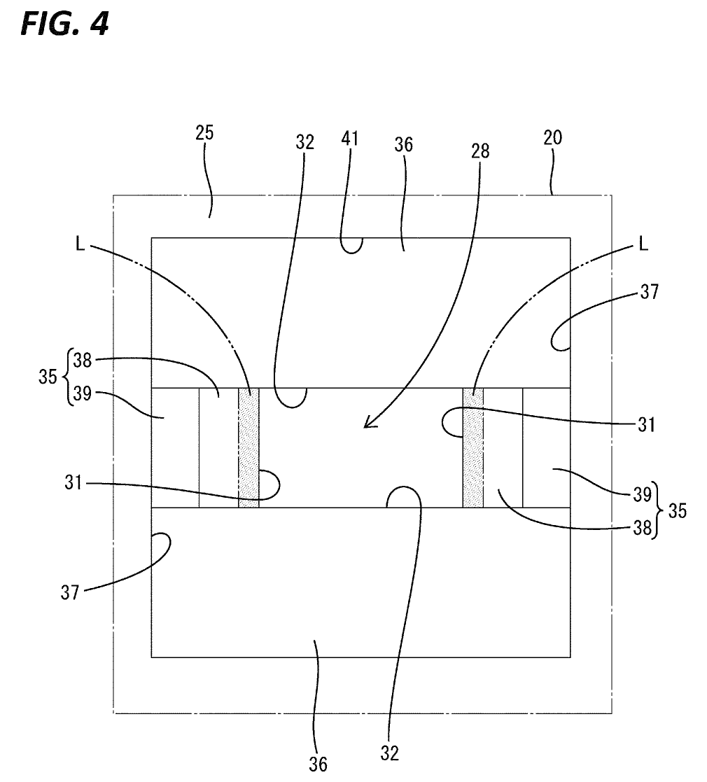

As shown in FIG. 4, the holding holes 28 each have a rectangular (oblong) opening shape (cross-sectional shape) that is longer in the left-right direction than in the up-down direction. A cross-sectional shape of the holding hole 28 is constant in the front-rear direction. The inner surfaces of the holding hole 28 consist of a pair of right and left third inner surfaces 31 facing each other in the left-right direction (third direction) and a pair of upper and lower second inner surfaces 32 facing each other in the up-down direction (second direction). The second inner surfaces 32 are disposed along the front-rear direction and the left-right direction. The third inner surfaces 31 are disposed along the front-rear direction and the up-down direction. The size in the left-right direction of the second inner surfaces 32 is larger than the size in the up-down direction of the third inner surfaces 31. The second inner surfaces 32 are orthogonal to the third inner surfaces 31, at four corners of the holding hole 28.

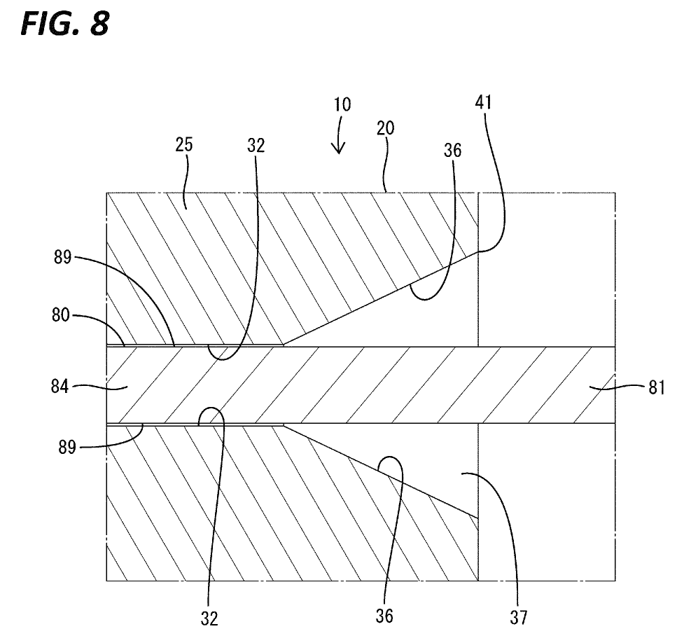

The distance (the separation distance in the up-down direction or the opening height) between the second inner surfaces 32 of the holding hole 28 is set to be equal to or larger than the distance between the second outer surfaces 89 of the held portion 85 (thickness). In the case shown in FIG. 7, the distance between the second inner surfaces 32 of the holding hole 28 is set to be equal to the distance between the second outer surfaces 89 of the held portion 85. In contrast, as shown in FIG. 8, the distance between the second inner surfaces 32 of the holding hole 28 may be set to be larger than the distance between the second outer surfaces 89 of the held portion 85. In the case shown in FIG. 8, the second inner surfaces 32 of the holding hole 28 may be disposed spaced apart from the second outer surfaces 89 of the held portion 85 in a non-contact manner with the second outer surfaces 89, respectively. As shown in FIG. 6, the distance (the lateral separation distance or the opening width) between the third inner surfaces 31 of the holding hole 28 is larger than the distance between the third outer surfaces 88 of the held portion 85, and is smaller than the distance between the vertices in the left-right direction of each pair of engaging portions 87 disposed in the left-right direction. Accordingly, the held portion 85 of the terminal fitting 80 is pressed into the holding hole 28 and is engaged with the wall portion 25 due to the engaging portions 87.

At a position near the front end of the wall portion 25, a diameter-enlarged surface 33 that expands in diameter from the front end of the holding hole 28 is provided. A surface extending from the diameter-enlarged surface 33 of the wall portion 25 to the front surface of the wall portion 25 is defined as a straight surface 34 that extends a short distance along the front-rear direction. The straight surface 34 is spaced apart from the extending portion 84.

As shown in FIGS. 4 and 6, the wall portion 25 has facing surfaces 35, guiding surfaces 36, and side inner surfaces 37 between the rear end of the holding hole 28 and the rear surface of the wall portion 25. The facing surfaces 35 are provided as a pair arranged in the left-right direction, and the side inner surfaces 37 are also provided as a pair arranged in the left-right direction. The guiding surfaces 36 are provided as a pair arranged in the up-down direction. Portions corresponding to the stoppers 91 of the terminal fitting 80 are respectively surrounded by the facing surfaces 35, the guiding surfaces 36, and the side inner surfaces 37.

The facing surfaces 35 are open rearward. The facing surfaces 35 have facing inclined surfaces 38 extending while being inclined laterally outward toward the rear respectively from the rear ends of the right and left inner surfaces of the holding hole 28, and stepped surfaces 39 extending laterally outward along the left-right direction respectively from the rear ends (outer ends in the left-right direction) of the facing inclined surfaces 38. As shown in FIG. 4, the facing inclined surfaces 38 and the stepped surfaces 39 are formed to have a height (in the up-down direction) that is constant in the left-right direction.

As shown in FIG. 7, the guiding surfaces 36 extend forward from the rear surface of the wall portion 25 in a tapered manner so as to approach each other in the up-down direction. The front ends of the guiding surfaces 36 intersect the rear ends of the second inner surfaces 32 and the facing surfaces 35 of the holding hole 28 at obtuse angles. As shown in FIG. 4, the size in the left-right direction of each guiding surface 36 is equal to a value obtained by adding the distance between the third inner surfaces 31 of the holding hole 28 and the sizes in the left-right direction of the facing surfaces 35. The guiding surface 36 has a height constant in the left-right direction.

The side inner surfaces 37 intersect both the ends in the left-right direction of the guiding surfaces 36 and ends left-right direction of the facing surfaces 35. The side inner surfaces 37 face each other in the left-right direction and are vertically disposed along the up-down direction and the front-rear direction. The distance between the side inner surfaces 37 is equal to the size in the left-right direction of the guiding surfaces 36. The rear ends of the side inner surfaces 37 and the rear ends of the guiding surfaces 36 define an insertion opening 41 in the rear surface of the wall portion 25, into which the mating connection portion 81 of the terminal fitting 80 can be inserted. The insertion opening 41 has, on the rear surface of the wall portion 25, a quadrangular opening shape, and more specifically, a square opening shape as viewed from the rear.

In addition, as shown in FIG. 3, the housing 20 has a pair of protective walls 42 protruding rearward from ends in the left-right direction of the wall portion 25. The protective walls 42 are disposed to cover the intermediate extending portions 82 and the board connection portions 83 of the terminal fittings 80 laterally from the outside. As shown in FIG. 1, the pair of side portions 24 have a pair of mounting wall portions 43 (only one is shown in FIG. 1) that extend forward from the protective walls 42 and are continuous with the protective walls 42, respectively. The rear ends of the fixing brackets 30 are held by the pair of mounting wall portions 43.

### Operations of Connector 10

When attaching a terminal fitting 80 to the housing 20, the held portion 85 of the mating connection portion 81 is inserted (press-fitted) into the holding hole 28 while being guided from the insertion opening 41 by the guiding surfaces 36 and the facing inclined surfaces 38. As shown in FIG. 6, when the terminal fitting 80 is properly attached to the housing 20, the held portion 85 is held in the wall portion 25 in a state of being prevented from coming off due to the engagement action of the engaging portions 87. As shown in FIGS. 3 and 5, the intermediate extending portion 82 and the board connection portion 83 are exposed and disposed rearward of the housing 20. The stoppers 91 are disposed laterally on the inner side of the side inner surfaces 37 while facing the facing surfaces 35 from the rear, respectively. The stoppers 91 abut against the stepped surfaces 39 of the facing surfaces 35, whereby the mating connection portion 81 is prevented from being press-fitted into the wall portion 25 in an excessive manner. Moreover, the fixing brackets 30 are respectively mounted to the side portions 24 of the hood portion 21 at appropriate timing.

In using the connector 10, the housing 20 is placed on the surface of the circuit board 100. The fixing brackets 30 are placed on a mounting portion (solder paste) on the surface of the circuit board 100. Similarly, the board connection portion 83 of the terminal fitting 80 is placed on the mounting portion of the surface of the circuit board 100. A reflow process is then performed, the fixing brackets 30 are soldered and fixed to the circuit board 100, and the board connection portion 83 of the terminal fitting 80 is soldered to the circuit board 100 to be electrically connected to a conductive portion (not illustrated) of the circuit board 100.

In order to improve mounting on the board and the like, the board connection portion 83 of the terminal fitting 80 is required to be appropriately disposed on the mounting portion of the surface of the circuit board 100 before the reflow process is performed. In the first embodiment, the second outer surfaces 89 of the held portion 85 are disposed in light contact with or close to the respective second inner surfaces 32 of the holding hole 28 in the front-rear direction. Therefore, a large vertically inward pressing force does not act on the held portion 85 from the wall portion 25. On the other hand, a relatively large vertically inward pressing force acts on the third outer surfaces 88 of the held portion 85 due to engagement action of the engaging portions 87. In short, in the first embodiment, interference sites L (see FIG. 4) between the held portion 85 and the wall portion 25 are limited to locations of interference from the left-right direction (engagement location of the engaging portions 87). In a process of inserting the held portion 85 into the holding hole 28, the second outer surfaces 89 of the held portion 85 can move in the front-rear direction along the respective second inner surfaces 32 of the holding hole 28. This can suppress tilting of the held portion 85 in the up-down direction inside the holding hole 28 and rotation of the held portion 85 about an axis of the mating connection portion 81.

The interference sites L between the held portion 85 and the wall portion 25 are limited to the locations of interference in the left-right direction, whereby variation in the holding position where the held portion 85 is held by the wall portion 25 can also be suppressed in a state where the held portion 85 is inserted into the holding hole 28. Accordingly, the mating connection portion 81 of the terminal fitting 80 is properly attached to the wall portion 25. Thus, before the reflow process is performed, the board connection portion 83 of the terminal fitting 80 is also disposed at an appropriate height in the up-down direction. Furthermore, also after the reflow process has been performed, it is possible to suppress variation in the holding position where the held portion 85 is held by the wall portion 25, and to maintain a state where the board connection portion 83 of the terminal fitting 80 is properly soldered to the circuit board 100.

As described above, the connector 10 according to the first embodiment includes the housing 20 and the terminal fittings 80. The housing 20 has the wall portion 25 having a thickness in the first direction (front-rear direction) and the holding holes 28 extending in the wall portion 25 in the first direction. The inner surfaces of each holding hole 28 consist of the pair of second inner surfaces 32 facing each other in the second direction (up-down direction) that intersects the first direction and the pair of third inner surfaces 31 facing each other in the third direction (left-right direction) that intersects both the first and second directions. Each terminal fitting 80 has the board connection portion 83 connected to the circuit board 100 outside the housing 20 and the held portion 85 that is disposed in the holding hole 28. The held portion 85 has the pair of second outer surfaces 89 directed in the second direction, the pair of third outer surfaces 88 directed in the third direction, and the pair of engaging portions 87 protruding outwardly in the third direction from the pair of third outer surfaces 88. The pair of engaging portions 87 of the held portion 85 are engaged with the pair of third inner surfaces 31 of the holding hole 28. The pair of second outer surfaces 89 of the held portion 85 are disposed close to or in contact with the pair of second inner surfaces 32 of the holding hole 28 along the third direction. The distance in the second direction between the pair of second inner surfaces 32 of the holding hole 28 is set to be equal to or larger than the distance in the second direction between the pair of second outer surfaces 89 of the held portion 85.

With the above configuration, the interference sites L between the held portion 85 and the wall portion 25 can be limited to the locations where the engaging portions 87 are engaged with the third outer surfaces 88, and thus the second outer surfaces 89 of the held portion 85 are not strongly pressed by the respective second inner surfaces 32 of the holding hole 28. Accordingly, variation in the holding position where the held portion 85 is held by the wall portion 25 are less likely to occur, making it possible to suppress positional variation of the board connection portion 83. As a result, coplanarity can be improved and the occurrence of a mounting failure can be suppressed. Particularly, since the engaging portions 87 each have a thickness in the second direction and are engaged with the third inner surfaces 31 over their entire thickness, the holding force with which the wall portion 25 holds the held portion 85 can be reliably ensured.

In addition, if the distance in the second direction between the second inner surfaces 32 of the holding hole 28 is larger than the distance in the second direction between the second outer surfaces 89 of the held portion 85 as shown in FIG. 8, it is easy to prevent the held portion 85 from being be pressed by the wall portion 25 in the second direction, and variation in the holding position where the held portion 85 is held on the wall portion 25 can be made less likely to occur. As a result, coplanarity can be further improved.

### Other Embodiments of Present Disclosure

The above first embodiment disclosed herein should be considered illustrative in all aspects, rather than restrictive.

In the above first embodiment, the connector is a horizontal-type connector in which both the mating connection portion and the board connection portion of each terminal fitting extend in the front-rear direction and are open in the direction along the surface of the circuit board. In contrast, according to another embodiment, the connector may be a vertical-type connector in which the mating connection portion and the board connection portion of the terminal fitting extend in directions intersecting each other and the hood portion is open in a direction intersecting the direction along the surface of the circuit board.

In the above first embodiment, the stoppers of the terminal fitting are spaced apart rearward from the facing surfaces. In contrast, according to another embodiment, the stoppers of the terminal fitting may be disposed so as to be in contact with the facing surfaces.

In the above first embodiment, the board connection portion of the terminal fitting is configured to be connected to and along the surface of the circuit board. In contrast, according to another embodiment, the board connection portion of the terminal fitting may be configured to be inserted into a through hole of the circuit board.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing;
and a terminal fitting,
wherein the housing includes a wall portion having a thickness in a first direction and a holding hole extending in the wall portion in the first direction,
the holding hole has a pair of second inner surfaces facing each other in a second direction that intersects the first direction and a pair of third inner surfaces facing each other in a third direction that intersects both the first and second directions,
the terminal fitting has a board connection portion connected to a circuit board outside the housing and a held portion disposed in the holding hole,
the held portion has a pair of second outer surfaces directed in the second direction, a pair of third outer surfaces directed in the third direction, and a pair of engaging portions protruding outward in the third direction from the pair of third outer surfaces,
the pair of engaging portions of the held portion are respectively engaged with the pair of third inner surfaces of the holding hole,
the pair of second outer surfaces of the held portion are respectively disposed in contact with or close to the pair of second inner surfaces of the holding hole along the third direction, and
a distance in the second direction between the pair of second inner surfaces of the holding hole is set to be equal to or larger than a distance in the second direction between the pair of second outer surfaces of the held portion.

2. The connector according to claim 1, wherein
the pair of engaging portions of the held portion have a thickness in the second direction and are respectively engaged with the pair of third inner surfaces over their entire thickness.

3. The connector according to claim 1, wherein
the distance in the second direction between the pair of second inner surfaces of the holding hole is larger than the distance in the second direction between the pair of second outer surfaces of the held portion.
